(19) United States
(12) Patent Application Publication
(10) Pub. No.: US 2009/0061906 A1
(43) Pub. Date: Mar. 5, 2009

(54) METHODS AND APPARATUS FOR LOCATION-BASED SERVICES IN WIRELESS NETWORKS

(75) Inventor: Ajay MALIK, Santa Clara, CA (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 11/848,921

(22) Filed: Aug. 31, 2007

(51) Int. Cl. H04Q 7/20

(52) U.S. Cl. 455/456.6

(57) ABSTRACT

Methods and systems are provided for location-based services in a wireless environment. The location-based service is provided on a mobile unit operating within an environment. A position of the mobile unit is determined within the wireless network environment using RFID or other wireless information received at a wireless switch. An available location-based service is identified in response to the position of the mobile unit, and subsequently provided using the mobile unit.

### TECHNICAL FIELD

The present invention relates to wireless local area networks (WLANs) and other networks incorporating RF elements and/or RF devices. More particularly, the present invention relates to location-based services provided via wireless networks.

### BACKGROUND

Wireless networks are becoming increasingly common. So called “Wi-Fi” networks based upon IEEE 802.11 standards, for example, are commonly available in many homes, businesses, airports, transit stations, hotels, retail establishments and other locations. Radio frequency identification (RFID) networks are similarly becoming widely deployed in retail and other commercial settings. As a result, relatively short-range wireless networks are becoming widely available to a large number of users.

Despite the rapid and wide deployment of wireless network infrastructures, additional capabilities and features of wireless connectivity remain largely unused. As a result, consumers are still demanding improved applications and features in wireless settings. It is therefore presently desirable to provide a wider array of features and services that make use of wireless infrastructure that is becoming increasingly available.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network useful in describing various embodiments;

FIG. 2 is a conceptual diagram of multiple mobile units associated with an access port and communicating with a wireless switch in accordance with one embodiment; and

FIG. 3 is a flowchart of an exemplary technique for providing a location-based service in a wireless network environment.

### DETAILED DESCRIPTION

By determining the position of a user (or a user device) within the wireless environment, services that are tailored specifically to that location can be provided. Such services may include advertising information (e.g. product information, coupons and/or offers) that is tailored to the particular products located near the user. Help or directional services (e.g. directions to a desired location, product, person or service) can be provided with specific “turn-by-turn” or other directions from the actual position of the user. Other services based upon the position of the user can be defined and provided as desired.

Generally speaking, position-based services are enabled through the use of on-board locationing within a network switch or other component operating within the wireless network environment. By determining the position of a mobile unit or other node within the environment, location-based services can be “pushed” out to the mobile unit at appropriate times and places. Alternatively, location based data can be “pulled” from the mobile unit in other embodiments wherein the mobile unit is simply appraised of its location within the wireless environment. Other features, options and aspects are described more fully below.

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission and data formatting protocols and that the system described herein is merely one example embodiment of the invention.

For the sake of brevity, conventional techniques related to signal processing, data transmission, signaling, network control, the 802.11 family of specifications, wireless networks, RFID systems and specifications, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

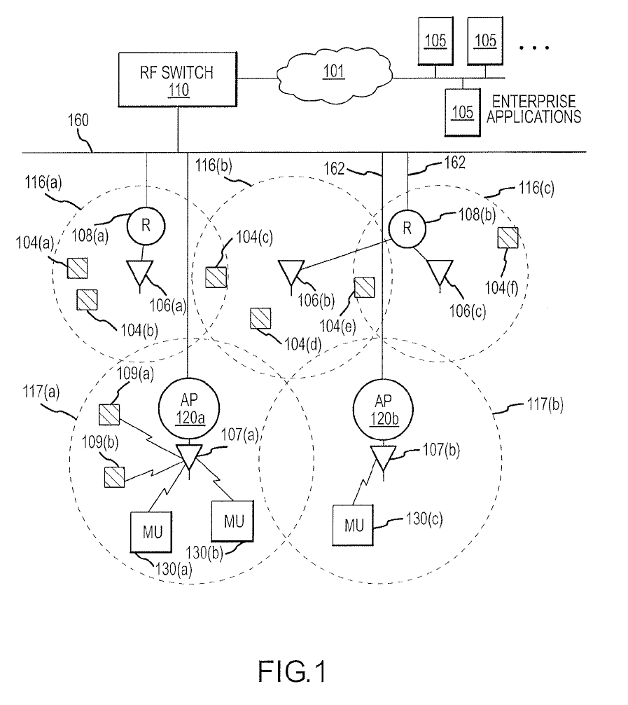

Referring to FIG. 1, in an example system useful in describing the present invention, a switching device 110 (alternatively referred to as an “RF switch,” “WS,” or simply “switch”) is coupled to a network 101 and 160 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 162 (e.g., conventional Ethernet lines, or the like). Any number of additional and/or intervening switches, routers, servers and other network components may also be present in the system.

A number of RF tags (“RFID tags,” or simply “tags”) 104, 107 may also be distributed throughout the environment. These tags, which may be of various types, are read by a number of RFID readers (or simply “readers”) 108 having one or more associated antennas 106 provided within the environment. The term “RFID” is not meant to limit the invention to any particular type of tag. The term “tag” refers, in general, to any RF element that can be communicated with and has an ID (or “ID signal”) that can be read by another component. Readers 108, each of which may be stationary or mobile, are suitably connective via wired or wireless data links to a RF switch 110. RFID functionality is shown in FIG. 1 to reflect RFID compatibility that may be available in certain embodiments, but this feature is not required to be present in all embodiments.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 120. These lists are generated using a suitable packet handling process as is known in the art. Thus, each AP 120 acts primarily as a conduit, sending/receiving RF transmissions via MUs 130, and sending/receiving packets via a network protocol with WS 110.

RF switch 110 can support any number of tags that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

Each antenna 106, 107 has an associated RF range 116, 117 106 (or “signal strength contour”) which depends upon, among other things, the strength of the respective antenna, and may be defined by a variety of shapes, depending upon the nature of the antenna (i.e., the RF range need not be circular or spherical as illustrated in FIG. 1). An antenna 107 coupled to an AP 120 may also communicate directly with RFID tags (such as tags 109(a) and 109(b), as illustrated). It is not uncommon for RF ranges to overlap in real-world applications (e.g., doorways, small rooms, etc.). Thus, as shown in FIG. 1, read point 116(a) overlaps with read point 116(b), which itself overlaps with read point 116(c), and range 117(a) overlaps with range 117(b).

As described in further detail below, switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller or switch 102 is modeled on a network switch architecture but includes RF network controller software (or “module”) whose capabilities include, among other things, the ability to allow configure and monitor readers 108 and antennas 106.

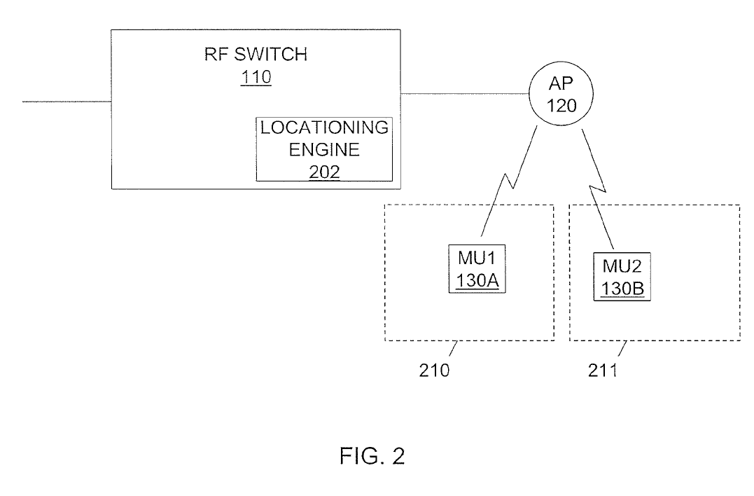

Referring to FIG. 2, RF switch 110 generally includes a locationing engine 202, as well as one or more other components—e.g., a cell controller (CC) and/or an RFID network controller (RNC) (not shown). The RNC includes hardware and software configured to handle RFID data communication and administration of the RFID network components, while the CC includes hardware and software configured to handle wireless data (e.g., in accordance with IEEE 802.11) from the mobile units and access ports within wireless cells. In one embodiment, RF switch 110 includes a single unit with an enclosure containing the various hardware and software components necessary to perform the various functions of the CC and RNC as well as suitable input/output hardware interfaces to networks 101 and 160. Thus, locationing engine 202 may be referred to as an “on-board” locationing engine in that is generally enclosed within or otherwise integral with RF switch 110. Locationing engine 202 within RF switch 110 can be used to facilitate location-based services such as those described elsewhere herein using signals received using RFID, IEEE 802.11 and/or other protocols as appropriate.

RF switch 110 is coupled to an AP 120, as previously described, which in turn is associated with and communicates with one or more MUs 130. Each AP 120 has an associated RF coverage area or signal strength contour, which corresponds to the effective range of its antenna or RF transmitter. These coverage areas may have any arbitrary shape or size, depending upon factors known in the art. For example, these coverage areas may be determined through a receiver signal strength indicator (RSSI) calculation, as is known in the art. APs 120 may comprise one or more processors accompanied by storage units, displays, input/output devices, an operating system, database management software, networking software, and the like. Such systems are well known in the art, and need not be described in detail here.

For wireless data transport, AP 120 may support one or more wireless data communication protocols—e.g., RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; GPRS; and proprietary wireless data communication protocols such as variants of Wireless USB.

In this illustration, there are two MUs: MU1 (130A), and MU2 (130B). MU1 is located within a one spatial region 210, and MU2 is located within another spatial region 211. Regions 210 and 211 may correspond to different rooms, floors, buildings, and the like, and have locations and characteristics known by locationing engine 202 a priori. The environment (and regions 210, 211) may correspond to physical spaces within a workplace, a retail store, a home, a warehouse, or any other such site, and will typically include various physical features that affect the nature and/or strength of RF signals received and/or sent by the APs. Such feature include, for example, architectural structures such as doors, windows, partitions, walls, ceilings, floors, machinery, lighting fixtures, and the like, and are preferably known by locationing engine 202. Note that the present invention is not limited to two-dimensional layouts; it may be implemented within three dimensional spaces as well.

In accordance with various embodiments, RF switch 110 is configured to support location-based services relating to MUs operating within the environment. Locationing engine 202 may therefore be configured to determine, with suitable accuracy, the position of one or more MUs 130 within the environment. This locationing may be performed in any convenient manner, including the use of triangulation based on signal strength (e.g. any RSSI method presently known or subsequently developed), the use of “near-me” RFID tags, and/or the like. In the triangulation method, for example, the signal strength of MU 130 corresponding to each AP is known a priori as the result of a suitable reporting mechanism, and this data can be used to map each MU 130 in space. While an exemplary 802.11-type environment is generally described above, the methods described herein apply equivalently to any locationing prediction that uses RSSI or other factors, including, for example, RFID, WiMax, WAN, Bluetooth, Zigbee, UWB, and the like.

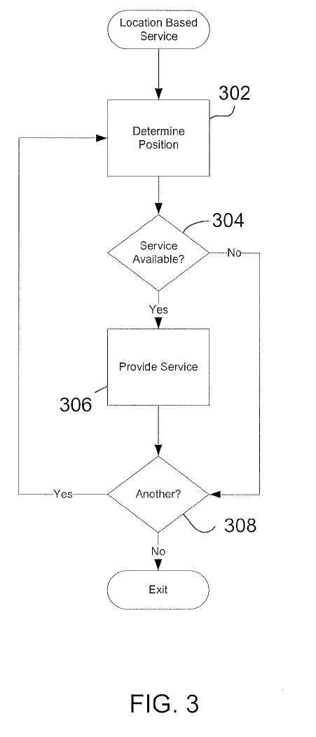

FIG. 3 shows an exemplary technique for providing location-based services to a user within a wireless environment. As shown in FIG. 3, an exemplary process 300 suitably includes the broad steps of determining a position of a user (step 302), identifying an available location-based service based upon the position of the user (step 304), and providing the available location-based service (step 306). Process 300 may be performed in hardware, software, firmware and/or any combination thereof. Moreover, the various steps need not be performed on a single component or module, but may be spread across various components operating in a system. For example, in one embodiment one or more software modules can be configured as a “locationing module” executed on a general purpose computer having a processor, memory, I/O, display, and the like. This module may be included with an AP 120, an MU 130, an enterprise application 105, and/or RF switch 110. Moreover, additional or alternate features could be included in any number of equivalent processes 300 without departing from the general concepts set forth herein.

Determining the location of the user (step 302) can be accomplished in any manner. In various embodiments, step 302 involves actually computing the location based upon RF signals (e.g. RFID, IEEE 802.11 and/or the like) received at any access point 120. The presence or absence of a signal received, the RSSI, and/or any other aspect of the RF signal can be used within locationing engine 202, for example, to triangulate or otherwise ascertain the position of any MU 130 or other user node operating within the wireless environment. In various equivalent embodiments, the “determining” referenced in step 302 simply refers to receiving positional information that was determined at another node or module. In this case, the position of the user can be determined in any manner at RF switch 110, application server 105, and/or the like, and information about the position can be transmitted to the mobile unit 130 as appropriate. Positional information may be based upon any sort of coordinate system (e.g. latitude/longitude, specialized coordinates specific to the environment, and/or the like), and may be encoded and transmitted in any manner.

After the position of the user is determined, any suitable position-related services may be identified (step 304) and provided (step 306) as appropriate. Services may be of any sort, including any type of advertising service, personal shopping service, mapping service, “help” or direction service, and/or the like. An advertising service, for example, may provide information to a user based upon objects (e.g. products) that are in relatively close proximity to the user's position. As a user enters a shopping aisle or other region of a retail establishment, for example, information about products or services available in that portion of the establishment could be provided. Such information could include pricing information and/or any sort of special offers, including coupons, discounts and/or the like. Further services available in alternate embodiments might include personal shopping services that could include, for example, providing information about products that are similar to those in proximity to the user, but not presently on the shelf or showroom floor. This information could be, for example, products maintained in an on or off-site storeroom, warehouse or the like. Still further, services could include directional services that provide specific instructions to the user to find a location of a support service (e.g. salesperson or technician), a rest room, or any other location within the environment. Such instructions could be provided based upon the actual position of the user, thereby ensuring highly reliable directions. In still other embodiments, the location-based service would include providing directions to a desired product or service available within the environment. If a customer was searching for a particular item within a store, for example, the customer could receive detailed instructions for finding the item based upon the current position of the customer and/or the item itself. Any number of position-based services could be formulated in a wide array of equivalent embodiments.

Services may be identified in any manner. In various embodiments, a server 105 monitors the position of one or more MUs 130 as they move about the environment. The server 105 then “pushes” offers to the user as the user physically approaches relevant trigger areas. An advertisement, coupon or other offer could be provided, for example, just as the customer is approaching the location of the advertised item in a store. Such information may be triggered by, for example, maintaining a database of relevant trigger areas (which may be defined based upon the same coordinate system used to represent the user's position) corresponding to locations within the environment. As the user's coordinate position entered into one of the trigger areas, the service can be triggered as appropriate.

In still other embodiments, step 304 is triggered in response to a request or “pull” from the user. The request may be a request for directions or other information, for example, or could be a manual or automatic request triggered by a mobile unit 130 for offers, advertisements or other information relating to objects located in proximity to the current position. “Proximity” in this sense means any useful distance. In some embodiments, “proximity” may relate to one or two meters or so, whereas in other embodiments “proximity” may be measured in tens of meters or more. Proximity may also be determined based upon velocity or acceleration of the user, or any other measure of a user's approach to an area or object of interest. Again, the available position-related services may be identified in any manner, with the particular identification of services varying widely depending upon the environment and the nature of the service provided.

The position-based services themselves may be provided in any manner (step 306). In various embodiments, step 306 involves providing information to MU 130 or another node associated with the user for simple displaying of information. In other embodiments, step 306 involves retrieving data from a server (e.g. server 105 or the like) to MU 130 for display or other presentation to the user. In other embodiments, step 306 may simply involve retrieving information stored locally on MU 130 for display to the user based upon positional information received from server 105 and/or any other component operating within the wireless network.

In the context of the above disclosure, FIG. 3 represents at least several exemplary embodiments of a process 300. In one embodiment, a server application (e.g. a software program residing at switch 110, server 105 and/or the like) is able to determine the position of the user (step 302) from received RF communications, to identify a relevant advertisement or other service based upon the position of the user (step 304), and to provide information to the MU 130 or other user node to allow the user node to display the location-based service. In another embodiment, a MU 130 or other node is able to receive information about its position (step 302), to locally identify any services available (step 304), and to present the available service (step 306) to the user as appropriate. In still other embodiments, a system approach is used to determine the position of the user (step 302) at a locationing engine 202 associated with wireless switch 110 or the like, relevant services are identified (step 304) at an enterprise server node 105, and services are provided on a personal digital assistant, portable phone, laptop computer and/or other MU device 130. All of these approaches may be combined, supplemented or otherwise modified to arrive at any number of alternate but equivalent embodiments.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A method for providing a location-based service on a mobile unit operating within an environment, comprising:
determining a position of the mobile unit within the wireless network environment;
identifying an available location-based service in response to the position of the mobile unit; and
providing the available location-based service.

2. The method of claim 1, wherein the step of determining a location of the mobile unit includes utilizing the signal strength of the mobile unit.

3. The method of claim 2, wherein utilizing the signal strength includes utilizing a receiver signal strength indicator (RSSI).

4. The method of claim 1, wherein the identifying step comprises comparing the position of the mobile unit to information regarding geographical details associated with the environment.

5. The method of claim 1 wherein the available location-based service is an advertising service.

6. The method of claim 1 wherein the available location-based service comprises providing information relating to a product located in proximity to the mobile unit.

7. The method of claim 1 wherein the available location based service is a mapping service.

8. The method of claim 1 wherein the available location based service is a directions service whereby a user of the mobile unit receives directional instructions selected based upon the position of the mobile unit.

9. The method of claim 1 wherein the available location-based service comprises providing information about additional products related to products located in proximity to the mobile unit.

10. The method of claim 9 wherein the available location-based service further comprises providing directions to a location of the additional products.

11. The method of claim 1 wherein the determining step comprises receiving information about the position from a wireless transmitter.

12. The method of claim 11 wherein the information about the position comprises coordinate data.

13. The method of claim 12 wherein the information about the position is determined at least in part from a locationing engine responsive to a data transmitted from the mobile unit.

14. A digital storage medium having computer-executable instructions stored thereon, wherein the instructions are configured to execute the method of claim 1.

15. A wireless network system for interacting with a mobile unit, the system comprising:
an access port configured to wirelessly communicate with the mobile unit;
a wireless switch coupled to the access port, the wireless switch including an on-board locationing engine configured to determine a position of the mobile unit in an environment; and
an application server in communication with the wireless switch, wherein the application server is configured to receive the position of the mobile unit from the wireless switch, to identify an available location-based service for the mobile unit based upon the position of the mobile unit, and to initiate the provision of the available location-based service on the mobile unit.

16. The system of claim 15, wherein the on-board locationing engine in the wireless switch utilizes stored information regarding geographical details associated with the environment.

17. The system of claim 15, wherein the application server utilizes stored information regarding geographical details associated with the environment.

18. A mobile unit configured to operate within an environment and to provide information to a user, the mobile unit comprising:
a wireless transmitter configured to transmit an identifying code to a wireless switch;
a wireless receiver configured to receive information about a position of the mobile unit within the environment; and
a processor coupled to the wireless receiver and configured to provide a location-based service to the user based upon the position of the mobile unit.

19. The mobile unit of claim 18 wherein the location-based service comprises providing information about objects located in proximity to position of the mobile unit.
